(19) United States
(12) Patent Application Publication
(10) Pub. No.: US 2023/0325562 A1
(43) Pub. Date: Oct. 12, 2023

(54) Machine Learning Method, Non-Transitory Computer Readable Recording Medium, Machine Learning Device, and Molding Machine

(71) Applicant: The Japan Steel Works, Ltd., Tokyo (JP)

(72) Inventor: Takayuki Hirano, Tokyo (JP)

(21) Appl. No.: 18/025,255

(22) PCT Filed: Aug. 3, 2021
(86) PCT No.: PCT/JP2021/028718

§ 371 Date: Mar. 8, 2023

(30) Foreign Application Priority Data
Sep. 9, 2020 (JP) 2020-151427

(51) Int. Cl. G06F 30/27

(52) U.S. Cl. CPC G06F 30/27; G06F 2119/18

(57) ABSTRACT

Provided is a machine learning method of a learning model that outputs a variable parameter that is configured to reduce the degree of defect of a molded article obtained by actual molding and relates to molding conditions of a molding machine in a case where observation data obtained by observing a physical quantity relating to actual molding using the molding machine is input. The machine learning method includes: a step of simulating a molding process by setting a variable parameter and a fixed parameter to a fluid analysis device; a step of acquiring a defect-related parameter that is obtained by simulation and relates to the degree of defect of the molded article; a step of calculating the degree of defect of the molded article on the basis of the acquired defect-related parameter; and a step of causing the learning model to perform machine learning by using the variable parameter set to the fluid analysis device and reward corresponding to the calculated degree of defect.

### CROSS-REFERENCE TO RELATED APPLICATIONS

This application is the national phase under 35 U. S. C. § 371 of PCT International Application No. PCT/JP2021/028718 which has an International filing date of Aug. 3, 2021 and designated the United States of America.

### BACKGROUND ART

The present disclosure relates to a machine learning method, a computer program, a machine learning device, and a molding machine.

There is an injection molding machine system that can appropriately adjust variable parameters (molding conditions) relating to molding conditions of a molding machine through reinforcement learning (for example, Japanese Patent Laid-Open Publication No. 2019-166702).

### DESCRIPTION

However, in the injection molding machine system related to Japanese Patent Laid-Open Publication No. 2019-166702, it is necessary to use the machine exclusively during reinforcement learning, and thus a resin material becomes a waste material. Accordingly, it is still desired to shorten learning man-hour.

An object of the present disclosure is to provide a machine learning method, a computer program, a machine learning device, and a molding machine which are capable of reducing actual molding man-hour using a molding machine for collecting learning data in machine learning of a learning model configured to adjust molding conditions of the molding machine.

A machine learning method according to an aspect is a machine learning method of a learning model that outputs a variable parameter in a case where observation data obtained by observing a physical quantity relating to actual molding using a molding machine is input to the learning model, wherein the variable parameter is configured to reduce the degree of defect of a molded article obtained by actual molding and relates to molding conditions of the molding machine. The machine learning method includes: simulating a molding process by setting a variable parameter and a fixed parameter to a fluid analysis device; acquiring a defect-related parameter that is obtained by simulation and relates to the degree of defect of the molded article; calculating the degree of defect of the molded article on the basis of the acquired defect-related parameter; and causing the learning model to perform machine learning by using the variable parameter set to the fluid analysis device and reward corresponding to the calculated degree of defect.

A computer program according to this aspect is a computer program causing a computer to perform machine learning of a learning model that outputs a variable parameter in a case where observation data obtained by observing a physical quantity relating to actual molding using a molding machine is input to the learning model, wherein the variable parameter is configured to reduce the degree of defect of a molded article obtained by actual molding and relates to molding conditions of the molding machine. The computer program causes the computer to execute processes of: simulating a molding process by setting a variable parameter and a fixed parameter to a fluid analysis device; acquiring a defect-related parameter that is obtained by simulation and relates to the degree of defect of the molded article; calculating the degree of defect of the molded article on the basis of the acquired defect-related parameter; and causing the learning model to perform machine learning by using the variable parameter set to the fluid analysis device and reward corresponding to the calculated degree of defect.

A machine learning device according to this aspect is a machine learning device that causes a learning model to perform machine learning, wherein the learning model outputs a variable parameter in a case where observation data obtained by observing a physical quantity relating to actual molding using a molding machine is input to the learning model, and the variable parameter is configured to reduce the degree of defect of a molded article obtained by actual molding and relates to molding conditions of the molding machine. The machine learning device includes: a simulation processing unit that simulates a molding process by setting a variable parameter and a fixed parameter to a fluid analysis device; an acquisition unit that acquires a defect-related parameter that is obtained by simulation by the fluid analysis device and relates to the degree of defect of the molded article; a calculation unit that calculates the degree of defect of the molded article on the basis of the defect-related parameter acquired by the acquisition unit; and a learning processing unit that causes the learning model to perform machine learning by using the variable parameter set to the fluid analysis device and the calculated degree of defect.

A molding machine according to this aspect is a molding machine including the machine learning device. Actual molding is performed by using a variable parameter output from the learning model.

According to the present disclosure, it is possible to reduce actual molding man-hour using a molding machine for collecting learning data in machine learning of a learning model configured to adjust molding conditions of the molding machine.

The above and further objects and features will more fully be apparent from the following detailed description with accompanying drawings.

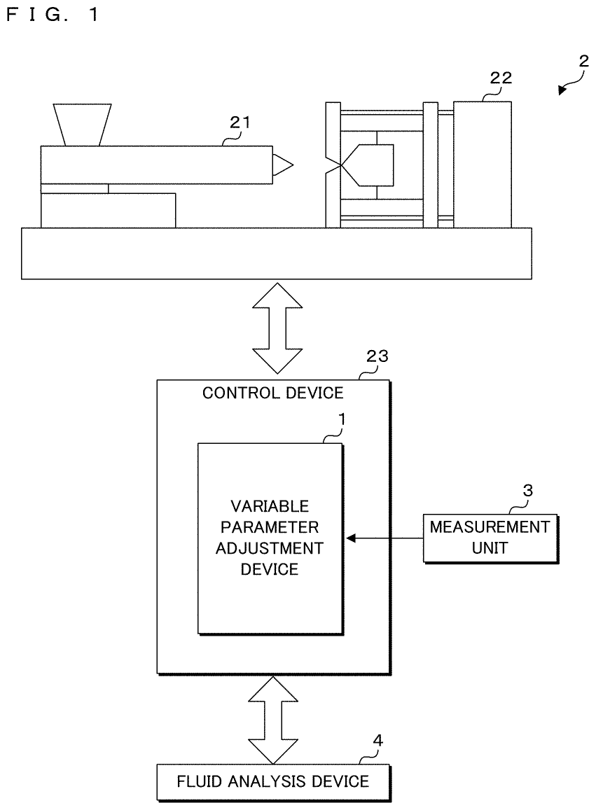

FIG. 1 is a schematic view describing a configuration example of a molding machine system according to an embodiment.

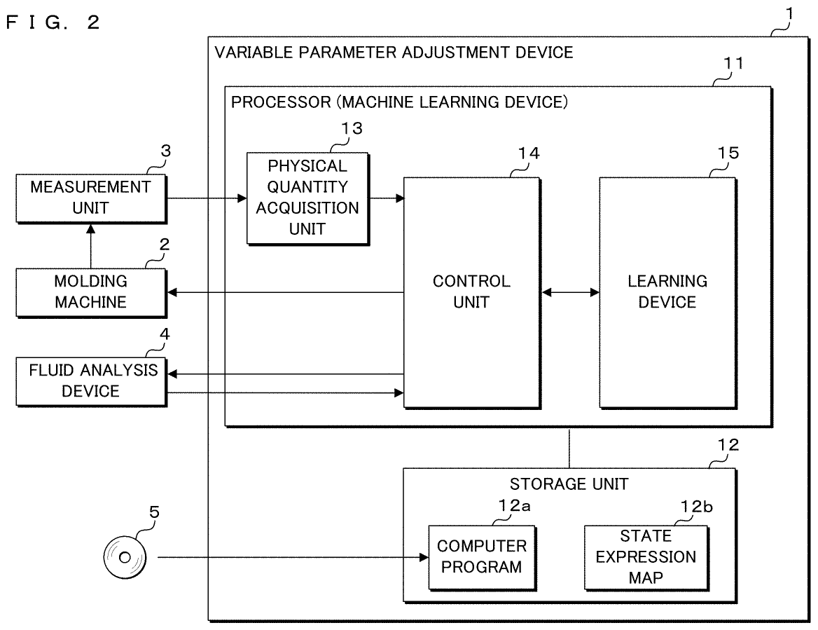

FIG. 2 is a block diagram illustrating the configuration example of the molding machine system according to this embodiment.

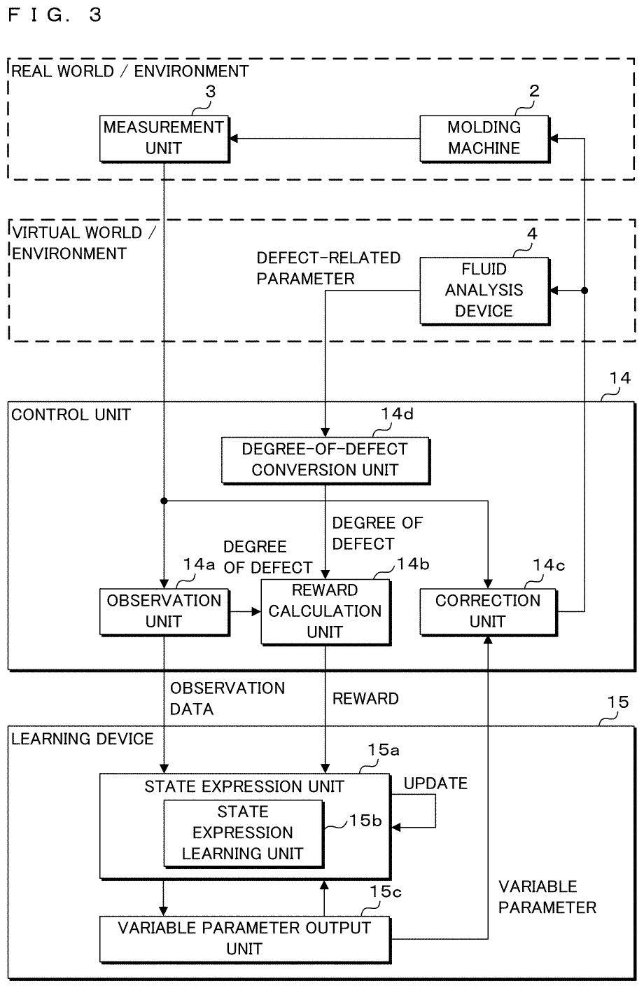

FIG. 3 is a functional block diagram of the molding machine system according to this embodiment.

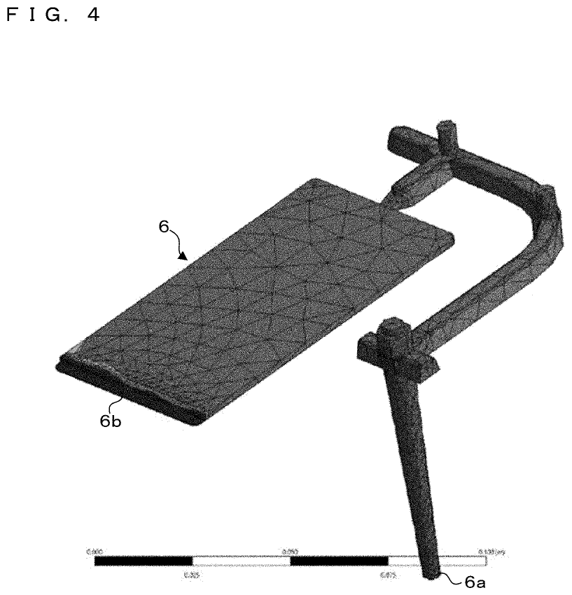

FIG. 4 is a schematic view illustrating an example of a molded article.

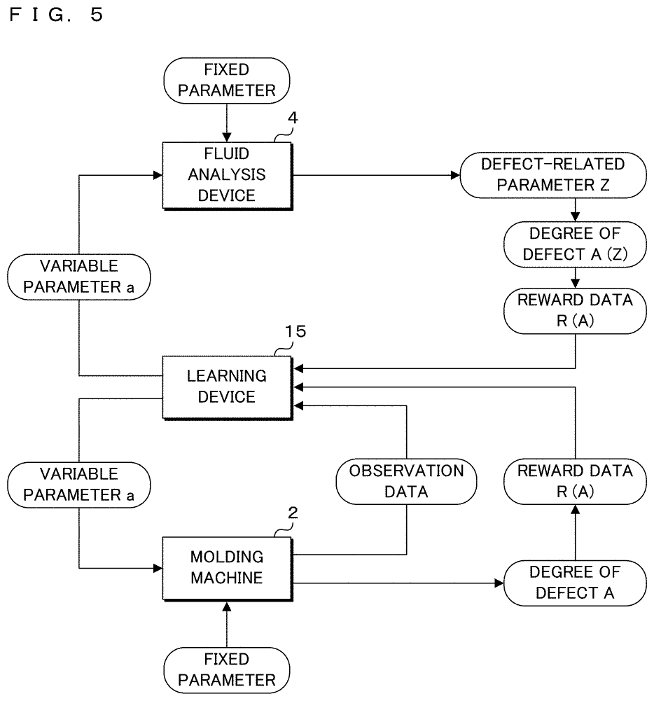

FIG. 5 is a conceptual diagram illustrating an overview of reinforcement learning according to this embodiment.

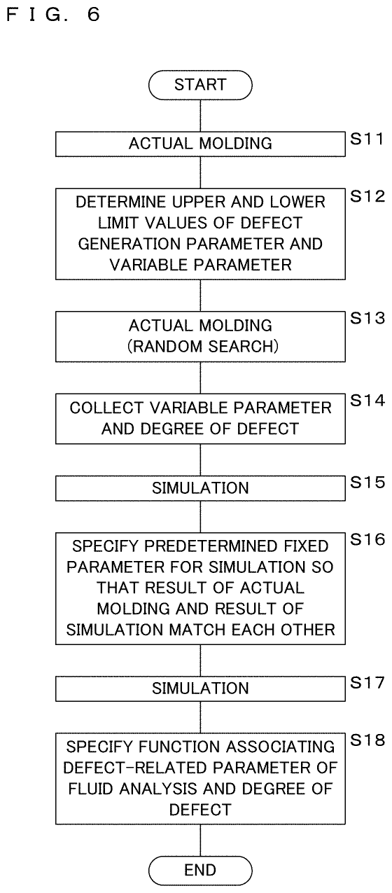

FIG. 6 is a flowchart illustrating a front-stage procedure of a processor in a learning phase.

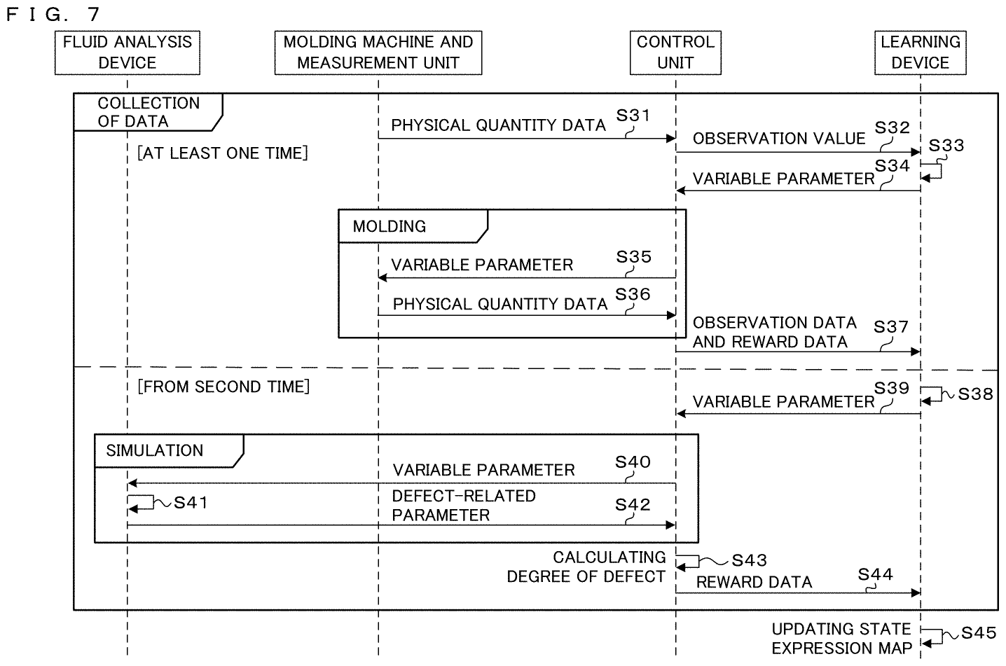

FIG. 7 is a sequence diagram illustrating a rear-stage procedure of the processor in the learning phase.

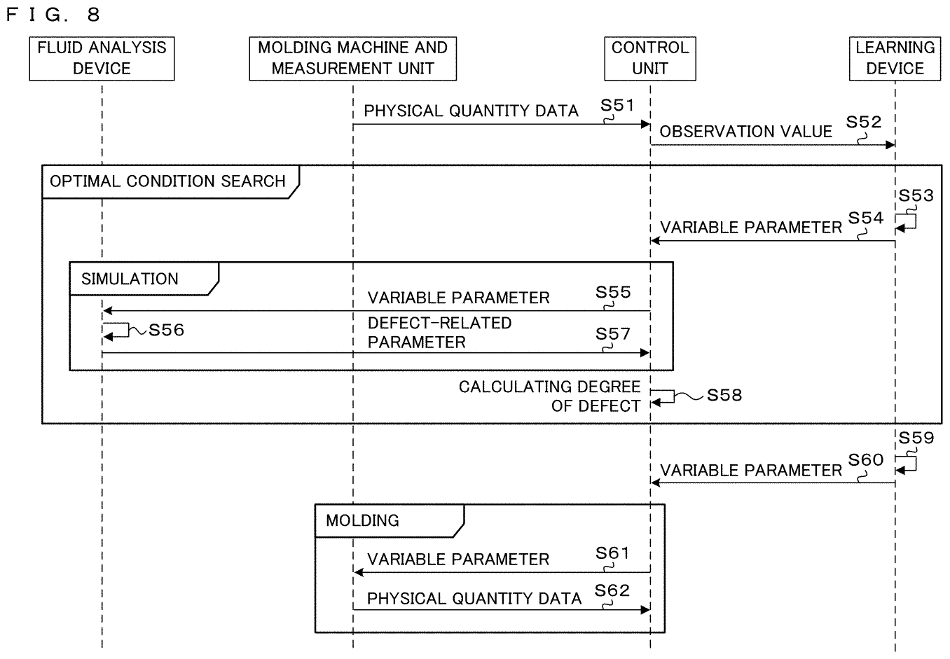

FIG. 8 is a sequence diagram illustrating a procedure of the processor in an operation phase.

Specific examples of a machine learning method, a computer program, a machine learning device, and a molding machine according to embodiments of the invention will be described with reference to the accompanying drawings hereinbelow. Note that, the invention is represented by the appended claims rather than being limited to the examples, and is intended to include meaning equivalent to the appended claims and all modification in the scope.

Hereinafter, the present disclosure will be described in detail with reference to the drawings illustrating the embodiments.

FIG. 1 is a schematic view describing a configuration example of a molding machine system according to an embodiment, FIG. 2 is a block diagram illustrating the configuration example of the molding machine system according to this embodiment, FIG. 3 is a functional block diagram of the molding machine system according to this embodiment, and FIG. 4 is a schematic view illustrating an example of a molded article 6. The molding machine system according to this embodiment includes a molding machine 2 including a variable parameter adjustment device 1, a measurement unit 3, and a fluid analysis device 4.

Examples of the molding machine 2 include an injection molding machine, a hollow molding machine, a film molding machine, an extruder, a twin-screw extruder, a spinning extruder, a granulator, a magnesium injection molding machine, and the like. Hereinafter, in this embodiment, description will be given on the assumption that the molding machine 2 is the injection molding machine. The molding machine 2 includes an injection device 21, a mold clamping device 22 disposed in front of the injection device 21, and a control device 23 that controls an operation of the molding machine 2.

The injection device 21 includes a heating cylinder, a screw that is provided to be driven in a rotation direction and an axial direction within the heating cylinder, a rotation motor that drives the screw in the rotation direction, a motor that drives the screw in the axial direction, and the like.

The mold clamping device 22 includes a toggle mechanism that opens and closes a mold, and clamps the mold so that the mold is not opened when the mold is filled with a molten resin injected from the injection device 21, and a motor that drives the toggle mechanism.

The control device 23 controls an operation of the injection device 21 and the mold clamping device 22. The control device 23 according to this embodiment includes the variable parameter adjustment device 1. The variable parameter adjustment device 1 is a device that adjusts variable parameters related to molding conditions of the molding machine 2, and particularly, the variable parameter adjustment device 1 according to this embodiment has a function of adjusting the variable parameters so that the degree of defect of a molded article 6 is reduced.

Parameters for determining molding conditions such as a resin temperature, a mold temperature, injection holding pressure time, a weighing value, a V/P switching position, a holding pressure, and an injection velocity are set to the molding machine 2, and the molding machine 2 operates in accordance with the parameters. Optimal parameters are different depending on an environment of the molding machine 2, and the molded article 6.

Note that, the V/P switching position is a switching position between injection velocity control and injection pressure control in injection molding. The injection velocity control is a control method of controlling injection of a resin material by controlling a velocity of a screw, and the injection pressure control is a method of controlling injection of the resin material by controlling a pressure applied to the screw.

Among the parameters, parameters which are targets to be adjusted by the variable parameter adjustment device 1 are referred to as variable parameters, and parameters which are not the targets to be adjusted are referred to as fixed parameters. The resin temperature, the mold temperature, the injection holding pressure time, and the weighing value are the fixed parameters. The weighing value, the V/P switching position, the holding pressure, and the injection velocity are the variable parameters. Note that, the fixed parameters noted here are parameters which can be used in both the molding machine 2 and the fluid analysis device 4, but a plurality of parameters such as a nozzle temperature, a cylinder temperature, a hopper temperature, and a mold clamping force are set to an actual molding machine 2 in addition to the fixed parameters. In addition, there is a fixed parameter such as a screw diameter that is set to only the fluid analysis device 4. Hereinafter, fixed parameters which are set to both the molding machine 2 and the fluid analysis device 4 will be considered for simplification of description.

Among the fixed parameters, a parameter for intentionally causing a defect of the molded article 6 to occur so as to collect learning data is referred to as a defect generation parameter. Examples of the defect generation parameter include the weighing value. The weighing value that is the defect generation parameter is changed, a defect such as burr and short of the molded article 6 can be intentionally caused to occur.

The measurement unit 3 is a device that measures a physical quantity related to actual molding when molding by the molding machine 2 is executed. The measurement unit 3 outputs physical quantity data obtained by measurement processing to the variable parameter adjustment device 1. Examples of the physical quantity include a temperature, a position, a velocity, acceleration, a current, a voltage, a pressure, time, image data, torque, a force, deformation, power consumption, and the like.

Examples of information measured by the measurement unit 3 include molding machine information, molded article information, and the like.

The molding machine information includes information such as a resin temperature, a mold temperature, a weighing value, a holding pressure, and an injection velocity which are obtained through measurement using a thermometer, a pressure gauge, a velocity measuring device, an acceleration measuring device, a position sensor, a timer, a weighing machine, and the like.

Examples of the molded article information include information such as a camera image obtained by imaging the molded article 6, a deformation amount of the molded article 6 which is obtained by a laser displacement sensor, a chromaticity of the molded article 6 which is obtained by an optical measurement device, an optically measured value such as luminance, the weight of the molded article 6 which is measured by a weighing machine, and strength of the molded article 6 which is measured by a strength measuring device. The molded article information expresses whether or not the molded article 6 is normal, a defect type, and the degree of defect, and is also used in calculation of reward. The molded article information of this embodiment also includes at least information for detecting burr and short of the molded article 6.

The fluid analysis device 4 is a numerical analysis simulator that sets the fixed parameters and the variable parameters which are molding conditions to a three-dimensional fluid analysis model, and simulates a resin temperature inside a mold, a resin pressure, a volume filling ratio, and the like of a resin material with respect to the mold in resin molding by numerical analysis such as a finite element method and a boundary element method. A numerical analysis method is not particularly limited.

The fluid analysis device 4 can perform data delivery with the variable parameter adjustment device 1. Specifically, the variable parameter adjustment device 1 provides fixed parameters and variable parameters to the fluid analysis device 4 so as to give an instruction for initiation of fluid analysis. Examples of the fixed parameters include a screw diameter, a type of a resin, a resin temperature, a mold temperature, injection holding pressure time, and a weighing value. The variable parameters include a weighing value of a resin material, a V/P switching position, a holding pressure, and an injection velocity.

The fluid analysis device 4 simulates a molding process in accordance with given parameter conditions, and outputs a simulation result to the variable parameter adjustment device 1. The simulation result includes a defect-related parameter relating to the degree of defect of the molded article 6.

The fluid analysis device 4 can simulate a resin temperature, a resin pressure, a volume filling ratio, and the like inside a mold in the molding process, but typically, a defect such as burr and short cannot be accurately reproduced, and information that directly represents a defect state cannot be output to the variable parameter adjustment device 1. Here, a defect-related parameter is output to the variable parameter adjustment device 1 as information for estimating the defect state of the molded article 6. Examples of the defect-related parameter include a tip end maximum resin pressure of the molded article 6, a volume filling ratio, a pressure, a temperature, a V/P switching position, a V/P switching pressure, viscosity, a solid phase rate, a skin layer thickness, a filling speed, filling acceleration, a shear stress, a stress, a density, a shear rate, shear energy, a thermal conductivity, and specific heat of the resin material in the mold, or an interfacial temperature between the resin and the mold. The tip end maximum resin pressure is a pressure in a tip end 6b (refer to FIG. 4) of the molded article 6 and is information related to a burr. When the tip end maximum resin pressure is excessively large, the burr occurs. The volume filling ratio is information related to a short. In a case where the volume filling ratio is less than 100% or a predetermined threshold value, the short occurs.

The variable parameter adjustment device 1 is a computer, and includes a processor 11 (machine learning device), a storage unit 12, an input/output interface (not illustrated), and the like as a hardware configuration as illustrated in FIG. 2. The processor 11 includes an arithmetic circuit such as a central processing unit (CPU), a multi-core CPU, a graphics processing unit (GPU), general-purpose computing on graphics processing units (GPGPU), a tensor processing unit (TPU), an application specific integrated circuit (ASIC), a field-programmable gate array (FPGA), and a neural processing unit (NPU), an internal storage device such as a read only memory (ROM) and a random access memory (RAM), an I/O terminal, and the like. The processor 11 functions as a physical quantity acquisition unit 13, a control unit 14, and a learning device 15 by executing a computer program (program product) 12a stored in a storage unit 12 to be described later. Note that, respective functional units of the variable parameter adjustment device 1 may be realized in a software manner, or a part or the entirety thereof may be realized in a hardware manner.

The storage unit 12 is a non-volatile memory such as a hard disk, an electrically erasable programmable ROM (EEPROM), and a flash memory. The storage unit 12 stores a computer program 12a for causing a computer to execute machine learning processing of a learning model that outputs variable parameters for reducing the degree of defect of the molded article 6 obtained by actual molding, and adjustment processing of the variable parameters by using the learning model in a case where observation data obtained by observing a physical quantity relating to actual molding using the molding machine 2 is input. In this embodiment, the processor 11 to the learning device 15 perform model-based type reinforcement learning and generate a state expression map 12b to be described later. The storage unit 12 stores the state expression map 12b generated by the learning device 15. Note that, the learning model according to this embodiment is constituted by the state expression map 12b, a state expression unit 15a, a variable parameter output unit 15c, and the like.

The computer program 12a according to this embodiment may be recorded in a recording medium 5 in a computer-readable manner. The storage unit 12 stores the computer program 12a read out from the recording medium 5 by a reading-out device (not illustrated). The recording medium 5 is a semiconductor memory such as a flash memory. In addition, the recording medium 5 may be an optical disc such as a compact disc (CD)-ROM, a digital versatile disc (DVD)-ROM, and a Blu-ray (registered trademark) disc (BD). In addition, the recording medium 5 may be a magnetic disk such as a flexible disk and a hard disk, a magneto-optical disk, or the like. Furthermore, the computer program 12a according to this embodiment may be downloaded from an external server (not illustrated) connected to a communication network (not illustrated), and may be stored in the storage unit 12.

The physical quantity acquisition unit 13 acquires physical quantity data that is measured and output by the measurement unit 3 when molding by the molding machine 2 is executed. The physical quantity acquisition unit 13 outputs the acquired physical quantity data to the control unit 14.

As illustrated in FIG. 3, the control unit 14 includes an observation unit 14a, a reward calculation unit 14b, a correction unit 14c, and a degree-of-defect conversion unit 14d. The physical quantity data output from the measurement unit 3 is input to the observation unit 14a and the correction unit 14c. A defect-related parameter output from the fluid analysis device 4 is input to the degree-of-defect conversion unit 14d.

The observation unit 14a observes a state of the molding machine 2 and the molded article 6 by analyzing the physical quantity data, and outputs observation data obtained through the observation to the state expression unit 15a of the learning device 15. Since the amount of information of the physical quantity data is large, the observation unit 14a may generate observation data obtained by compressing information of the physical quantity data. The observation data is information representing a state of the molding machine 2, a state of the molded article 6, or the like.

For example, the observation unit 14a calculates observation data that represents a feature quantity indicating an appearance feature of the molded article 6, dimensions, an area, and a volume of the molded article 6, an optical axis deviation amount of the optical component (molded article 6), and the like on the basis of a camera image and a measurement value of a laser displacement sensor. In addition, the observation unit 14a may execute preprocessing with respect to time-series waveform data such as an injection velocity, an injection pressure, and a holding pressure, and may extract a feature quantity of the time-series waveform data as the observation data. Note that, time-series data of the time-series waveform or image data representing the time-series waveform may be set as the observation data.

In addition, the observation unit 14a calculates the degree of defect of the molded article 6 by analyzing the physical quantity data, and outputs the degree of defect obtained through calculation to the reward calculation unit 14b. Examples of the degree of defect include a burr area, and a short area.

The degree-of-defect conversion unit 14d is provided with a function (association information) for converting a defect-related parameter output from the fluid analysis device 4 into the degree of defect. The degree-of-defect conversion unit 14d calculates the degree of defect by inputting the defect-related parameter to the function, and outputs the degree of defect obtained through calculation to the reward calculation unit 14b. A method of creating the function will be described later.

Note that, the function is illustrative only, and an association method is not particularly limited as long as the defect-related parameter and the degree of defect can be associated. For example, a table in which the defect-related parameter and the degree of defect are associated may be used instead of the function.

The reward calculation unit 14b calculates reward data that becomes a reference for determining whether the variable parameter is good or bad on the basis of the degree of defect output from the observation unit 14a and the degree-of-defect conversion unit 14d, and outputs the reward data obtained through the calculation to the state expression unit 15a of the learning device 15.

The correction unit 14c corrects the variable parameter output from the learning device 15 as necessary, and outputs the corrected variable parameter to the molding machine 2 and the fluid analysis device 4. For example, in a case where an upper limit value, a lower limit value, or the like is set in the variable parameter, the variable parameter may be corrected so that a value relating to molding conditions does not exceed the upper limit value or the lower limit value. In a case where correction is not necessary, the correction unit 14c outputs the variable parameter output from the learning device 15 to the molding machine 2 and the fluid analysis device 4 as is.

The learning device 15 performs model-based type reinforcement learning of learning the state expression map 12b (environment model) that expresses a state of the molding machine 2, and determining the variable parameter by using the state expression map 12b. The learning device 15 includes the state expression unit 15a, a state expression learning unit 15b, and the variable parameter output unit 15c as illustrated in FIG. 3.

A molding device system according to this embodiment includes a learning phase of performing learning of the state expression map 12b, and an operation phase of optimizing the variable parameter by using the state expression map 12b and performing molding. The molding device system may accept switching of the learning phase and the operation phase with an operating panel (not illustrated).

Description will be given of learning data collection and a learning method by actual molding using the molding machine 2 that is an actual machine. In the learning phase of performing learning of the state expression map 12b, observation data output from the observation unit 14a, reward data output from the reward calculation unit 14b, and a variable parameter output from the variable parameter output unit 15c are input to the state expression unit 15a. The state expression unit 15a is provided with the state expression learning unit 15b, and the state expression learning unit 15b learns the state expression map 12b on the basis of the observation data, the variable parameter, and the reward data which are input.

The state expression map 12b is a model that outputs a reward g with respect to setting of the variable parameter (action a) in a state s, and a state transition probability (degree of certainty) Pt to the subsequent state s′, for example, in a case where the observation data (state s) and the variable parameter (action a) are input. The reward g can be said to be information representing whether or not the molded article 6 that is obtained when setting an arbitrary variable parameter (action a) in the state s is normal.

The state expression learning unit 15b creates or updates the state expression map 12b on the basis of experience data (state s, action a, subsequent state s′, reward g) that is learning data or history data. For example, the state expression learning unit 15b may calculate state transition probability Pt corresponding to a value obtained by dividing the number of times of visit n to (state s, action a, subsequent state s′) by the number of times of visit Σn to (state s, action a, arbitrary subsequent state s′∈S) by using a maximum estimation method, a Bayesian estimation, or the like. In addition, the state expression unit 15a may calculate the reward g (information representing whether the molded article 6 is good or bad) corresponding to a value obtained by dividing a reward sum G in (state s, action a) by the number of times of visit Σn to (state s, action a, arbitrary subsequent state s′) by using the maximum estimation method, the Bayesian estimation, or the like.

In addition, the state expression map 12b can be configured by using a trained model using a neural network. The neural network has a known configuration including an input layer, one or a plurality of hidden layers, and an output layer. The state expression learning unit 15b may train the neural network so that (subsequent state s′, reward g) is output from the neural network in a case where (state s, action a) of learning data is input to the neural network.

In a case of the operation phase of operating the molding machine 2 by using the created state expression map 12b, observation data and a variable parameter output from the variable parameter output unit 15c are input to the state expression unit 15a. The state expression unit 15a inputs observation data representing a current state, and a variable parameter to the state expression map 12b, obtains state expression data representing the state transition probability Pt from the current state to the subsequent state s′ and the reward g, and outputs the state expression data to the variable parameter output unit 15c.

The variable parameter output unit 15c determines a variable parameter with which a predetermined objective function becomes maximum on the basis of the state expression data output from the state expression unit 15a, and outputs the determined variable parameter to the correction unit 14c and the state expression unit 15a. For example, the variable parameter output unit 15c determines the variable parameter by using a known method such as a dynamic programming method such as value iteration, and a linear programming method.

The variable parameter output unit 15c includes a switching unit, a first evaluation unit, a second evaluation unit, and a variable parameter determination unit (not illustrated).

The switching unit outputs state expression data to the first evaluation unit in a case of the operation phase, and outputs the state expression data to the second evaluation unit in a case of the learning phase.

The first evaluation unit includes a first objective function for adjusting the variable parameter to be a state in which a normal molded article 6 is obtained. The first evaluation unit calculates an evaluation value that is an expected return (discount cumulative reward) by inputting the state expression data and the variable parameter to the first objective function. The expected return is an expected value of a reward sum to be obtained in the future.

The second evaluation unit includes a second objective function for adjusting the variable parameter so that the state of the molded article 6 varies so as to search the state expression map 12b. The second evaluation unit calculates an evaluation value that further increases, for example, as the state of the molding machine 2 and a molding result for the variable parameter are unknown, that is, as the number of times of trials is small, by using the state expression data and the variable parameter to the second objective function. Note that, the second evaluation unit can calculate the evaluation value by using a searching method such as a so-called ε-greedy method and UCB1.

The variable parameter determination unit determines a variable parameter with which the evaluation value calculated by the first evaluation unit becomes maximum in a case of the operation phase, and determines a variable parameter with which the evaluation value calculated by the second evaluation unit becomes maximum in a case of the learning phase. The variable parameter output unit 15c outputs the variable parameter determined by the variable parameter determination unit to the state expression unit 15a and the correction unit 14c.

Note that, the variable parameter determination unit may determine the variable parameter so that the amount of change in the variable parameter per one step in the learning phase becomes greater than the amount of change in the variable parameter per one step in the operation phase. In addition, the variable parameter adjustment device 1 may be configured so that setting of the amount of change in the variable parameter per one step is accepted from an operator with an operation panel (not illustrated). In a case of updating the state expression map 12b, the variable parameter determination unit changes the variable parameter with the amount of change accepted, and searches and updates the state expression map 12b. In a case where a mold, the molding machine 2, a model of a peripheral device, a physical property of a resin is greatly changed, the amount of change in the variable parameter in the learning phase may be set to be large.

FIG. 5 is a conceptual diagram illustrating an overview of reinforcement learning according to this embodiment. The reinforcement learning according to this embodiment is performed by using a molding result obtained by using the molding machine 2 that is an actual machine, and the simulation result obtained by using the fluid analysis device 4 in combination.

First, actual molding is performed by setting a fixed parameter and a variable parameter to the molding machine 2. Then, reward data corresponding to the degree of defect of the molded article 6 obtained by the actual molding, and observation data obtained by observing a physical quantity relating to the actual molding are input to the learning device 15, and the learning device 15 perform machine learning. The learning device 15 outputs an optimal variable parameter based on current observation data to the molding machine 2 and the fluid analysis device 4. That is, in a case where a defect occurs in the molded article 6, the learning device 15 outputs a variable parameter for reducing the degree of defect of the molded article 6. Note that, when creating the state expression map 12b by the reinforcement learning, an event that intentionally causes a defect to occur in the molded article 6 is created by changing a defect generation parameter, and an optimal variable parameter when the defect occurs is learned. The state expression map 12b may be generated by repeatedly performing the actual molding, but a resin material during the reinforcement learning becomes a waste material.

Here, the reinforcement learning is performed by using the fluid analysis device 4. Specifically, the variable parameter output from the learning device 15 is set to the fluid analysis device 4 to simulate a molding process. A defect-related parameter that is obtained by simulation and relates to the degree of defect of the molded article 6 is converted into the degree of defect of the molded article 6, and reward data corresponding to the degree of defect is calculated. The reward data and the observation data are input to the learning device 15, and the learning device performs machine learning. Note that, with regard to data representing a state of the molding machine 2 among a plurality of pieces of the observation data, an observation value obtained by measuring a physical quantity relating to actual molding is used as a fixed value. Hereinafter, it is possible to train the state expression map 12b by repeatedly executing simulation by the fluid analysis device 4 and machine learning.

Hereinafter, details of the machine learning method according to this embodiment will be described.

[Matching of Molding Machine 2 and Fluid Analysis Device 4]

FIG. 6 is a flowchart illustrating a front-stage procedure of the processor 11 in the learning phase. The following processing may be performed by a worker, or a part or the entirety thereof may be automatically performed by the processor 11. First, a fixed parameter and a variable parameter are set to the molding machine 2, and actual molding using the molding machine 2 is performed (step S11). Here, actual molding is performed a plurality of times by appropriately changing the defect generation parameter and the variable parameter.

Next, upper and lower limit values of the defect generation parameter and the variable parameter are determined on the basis of a result of the actual molding in step S11 (step S12).

Next, the variable parameter and the defect generation parameter are fluctuated within a range of the upper and lower limit values determined in step S12, actual molding using the molding machine 2 is performed (step S13), and the variable parameter used in the actual molding and the degree of defect of the molded article 6 which is obtained by the actual molding are collected (step S14).

Next, molding conditions other than arbitrary one fixed parameter (hereinafter, referred to as “predetermined parameter”) are set to the same conditions as in step S13, and a predetermined parameters for a plurality of simulations are set to the fluid analysis device 4 to simulate molding processes (step S15). The predetermined parameters are obtained by making a change in a predetermined parameter value which is set to the molding machine 2 for the actual machine. That is, the predetermined parameters for the plurality of simulations are values different from the predetermined parameter for the actual machine, and the predetermined parameters for simulations which are values different from a value for the actual machine are set to the fluid analysis device 4 to simulate the molding process. In addition, a predetermined fixed parameter for simulation is specified so that a result of the actual molding using the molding machine 2, and a result of the simulation using the fluid analysis device 4 match each other (step S16).

Even when the same fixed parameter and variable parameter may be set to the molding machine 2 and the fluid analysis device 4, a molding result, that is, a state of the molded article 6 is different. Therefore, it is necessary to make the result of the actual molding and the simulation result match each other. The matching is performed by adjusting the predetermined fixed parameter set to the fluid analysis device 4.

For example, the matching may be performed by adjusting a resin temperature that is set to fluid analysis device 4. A resin temperature that is set to the molding machine 2 is a temperature of a predetermined portion of the injection device 21 instead of the mold. On the other hand, the resin temperature that is set to the fluid analysis device 4 is a temperature of an injection portion 6a (refer to FIG. 4) through which a resin is injected to the mold. Typically, the resin temperature of the injection portion 6a is expected to be lower than the resin temperature of the predetermined portion of the injection device 21. Accordingly, the resin temperature that is set to the fluid analysis device 4 is set to a resin temperature lower than the resin temperature that is set to the molding machine 2 that is an actual machine.

Next, the molding conditions other than the resin temperature are set to the same conditions as in step S13, and the resin temperature specified in step S16 is set to the fluid analysis device 4 to simulate the molding process (step S17).

Next, a function of associating the degree of defect of the molded article 6 obtained by actual molding performed by setting the variable parameter to the molding machine 2 and the defect-related parameter obtained by simulation using the same variable parameter as the variable parameter set to the molding machine 2 is specified (step S18). When associating the defect-related parameter and the degree of defect, an analysis model or an analysis method may be corrected as necessary, and the performance of function approximation between the defect-related parameter and the degree of defect may be heuristically raised.

Note that, as described above, the function is an example, and an association method is not particularly limited as long as the defect-related parameter and the degree of defect can be associated. For example, a table in which the defect-related parameter and the degree of defect are associated with each other may be specified instead of the function.

FIG. 7 is a sequence diagram illustrating a rear-stage procedure of the processor 11 in the learning phase. Step S31 to step S37 in FIG. 7 are processes of collecting learning data by actual molding using the molding machine 2 that is an actual machine, and step S38 to step S44 are processing of collecting learning data by a molding process simulation using the fluid analysis device 4. Data collection is performed a plurality of times. At least at the first time, collection of learning data is performed by using the molding machine 2 that is an actual machine. From the second time, collection of the learning data is performed by actual molding or simulation. From the second time, all pieces of learning data may be collected by simulation, or a part thereof may be collected simulation. A detailed data collection procedure is as follows.

[Collection of Learning Data by Actual Molding]

First, the measurement unit 3 measures physical quantities relating to the molding machine 2 and the molded article 6 when the molding machine 2 executes molding, and outputs physical quantity data obtained through measurement to the control unit 14 (step S31).

The control unit 14 acquires the physical quantity data output from the measurement unit 3, generates observation data based on the acquired physical quantity data, and outputs the generated observation data to the learning device 15 (step S32).

The state expression unit 15a of the learning device 15 acquires the observation data output from the observation unit 14a, creates state expression data by applying the observation data to the state expression map 12b, and outputs the created state expression data to the variable parameter output unit 15c (step S33). The variable parameter output unit 15c determines a variable parameter of the molding machine 2 on the basis of the state expression data output from the state expression unit 15a, and outputs the determined variable parameter to the state expression unit 15a and the control unit 14 (step S34). For example, the variable parameter output unit 15c determines a variable parameter with which an evaluation value obtained from the second objective function becomes maximum as described above.

The correction unit 14c of the control unit 14 corrects the variable parameter as necessary, and outputs the corrected variable parameter to the molding machine 2 (step S35). The molding machine 2 sets the variable parameter, and performs molding processing in accordance with the variable parameter. Physical quantities relating to an operation of the molding machine 2 and the molded article 6 are input to the measurement unit 3. The molding processing may be repeatedly performed a plurality of times. The measurement unit 3 measures physical quantities relating to the molding machine 2 and the molded article 6 when the molding machine 2 executes molding, and outputs physical quantity data obtained through measurement to the observation unit 14a of the control unit 14 (step S36).

The observation unit 14a acquires the physical quantity data output from the measurement unit 3, generates observation data based on the acquired physical quantity data, and outputs the generated observation data to the learning device 15 (step S37). In addition, the reward calculation unit 14b calculates reward data that is determined in correspondence with the degree of defect of the molded article 6 on the basis of the physical quantity data measured by the measurement unit 3, and outputs the calculated reward data to the learning device 15 (step S37).

[Collection of Learning Data by Simulation]

On the other hand, the state expression unit 15a of the learning device 15 acquires the observation data output from the observation unit 14a, creates state expression data by applying the observation data or the like to the state expression map 12b, and outputs the created state expression data to the variable parameter output unit 15c (step S38). The variable parameter output unit 15c determines a variable parameter of the molding machine 2 on the basis of the state expression data output from the state expression unit 15a, and outputs the determined variable parameter to the state expression unit 15a and the control unit 14 (step S39).

The correction unit 14c of the control unit 14 corrects the variable parameter as necessary, and outputs the corrected variable parameter to the fluid analysis device 4 (step S40). The fluid analysis device 4 sets the fixed parameter and the variable parameter, and performs molding processing in accordance with the variable parameter (step S41). The fluid analysis device 4 outputs a defect-related parameter obtained by simulation of the molding process to the control unit 14 (step S42).

The degree-of-defect conversion unit 14d of the control unit 14 inputs the defect-related parameter output from the fluid analysis device 4 to the function that is specified in step S18 to convert the defect-related parameter to the degree of defect of the molded article 6, and outputs the converted degree of defect to the reward calculation unit 14b (step S43).

The reward calculation unit 14b calculates reward data determined in correspondence with the degree of defect, and outputs the calculated reward data to the learning device 15 (step S44).

The control unit 14 can collect learning data by processing of step S31 to step S44.

In addition, the state expression learning unit 15b of the learning device 15 updates a state expression model on the basis of the observation data output from the observation unit 14a, the reward data output from the reward calculation unit 14b, and the variable parameter output from the variable parameter output unit 15c (step S45). The state expression learning unit 15b may update the state expression model, for example, by using a maximum estimation method, a Bayesian estimation, or the like.

Note that, when performing machine learning of the state expression map 12b, the degree of defect of the molded article 6 is intentionally caused to occur or the variable parameter is greatly fluctuated by changing the defect generation parameter. However, when considering that the observation data is fixed, it is preferable to avoid excessive fluctuation of the observation data at the time of random search by actual molding.

FIG. 8 is a sequence diagram illustrating a procedure of the processor in the operation phase. The measurement unit 3 measures physical quantities relating to the molding machine 2 and the molded article 6 when the molding machine 2 executes molding, and outputs physical quantity data obtained through measurement to the control unit 14 (step S51).

The control unit 14 acquires the physical quantity data output from the measurement unit 3, generates observation data based on the acquired physical quantity data, and outputs the generated observation data to the learning device 15 (step S52).

The state expression unit 15a of the learning device 15 acquires the observation data output from the observation unit 14a, creates state expression data by applying the observation data to the state expression map 12b, and outputs the created state expression data to the variable parameter output unit 15c (step S53). The variable parameter output unit 15c determines a variable parameter of the molding machine 2 on the basis of the state expression data output from the state expression unit 15a, and outputs the determined variable parameter to the state expression unit 15a and the control unit 14 (step S54). For example, the variable parameter output unit 15c determines a variable parameter with which an evaluation value obtained from the first objective function becomes maximum as described above.

The correction unit 14c of the control unit 14 corrects the variable parameter as necessary, and outputs the corrected variable parameter to the fluid analysis device 4 (step S55). The fluid analysis device 4 sets the fixed parameter and the variable parameter, and performs molding processing in accordance with the variable parameter (step S56). The fluid analysis device 4 outputs a defect-related parameter obtained by simulation of the molding process to the control unit 14 (step S57).

The degree-of-defect conversion unit 14d of the control unit 14 inputs the defect-related parameter output from the fluid analysis device 4 to the function that is specified in step S18 to convert the defect-related parameter to the degree of defect of the molded article 6, and outputs the converted degree of defect to the reward calculation unit 14b (step S58).

In a case where the defect of the molded article 6 is not resolved, the variable parameter may be adjusted by repeatedly executing the processing of step S53 to step S58.

The reward calculation unit 14b calculates reward data determined in correspondence with the degree of defect, and outputs the calculated reward data to the learning device 15 (step S59).

Processing subsequent to step S59 will be described.

The state expression unit 15a of the learning device 15 acquires the observation data output from the observation unit 14a, creates state expression data by applying the observation data to the state expression map 12b, and outputs the created state expression data to the variable parameter output unit 15c (step S59). The variable parameter output unit 15c determines a variable parameter of the molding machine 2 on the basis of the state expression data output from the state expression unit 15a, and outputs the determined variable parameter to the state expression unit 15a and the control unit 14 (step S60).

The correction unit 14c of the control unit 14 corrects the variable parameter as necessary, and outputs the corrected variable parameter to the molding machine 2 (step S61). The measurement unit 3 measures physical quantities relating to the molding machine 2 and the molded article 6 when the molding machine 2 executes molding, and outputs physical quantity data obtained through measurement to the observation unit 14a of the control unit 14 (step S62). Hereinafter, it is possible to automatically adjust the variable parameter that is set to the molding machine 2 so that defects do not occur in the molded article 6 by repeatedly executing the processing of step S51 to step S62.

According to the machine learning method, the computer program 12a, the machine learning device, and the molding machine 2 configured as described above according to this embodiment, when the simulation result is used in addition to actual molding, it is possible to reduce actual molding man-hour using the molding machine 2 for collecting the learning data, and it is possible to efficiently train the learning device 15.

In addition, when the resin temperature that is set to the fluid analysis device 4 is set to a resin temperature lower than the resin temperature that is set to the molding machine 2 that is an actual machine, it is possible to match a simulation result and a result of actual molding with each other in a simple manner.

In addition, when the defect-related parameter obtained by simulation is converted into the degree of defect of the molded article 6, the fluid analysis device 4 and the learning device 15 can be connected to each other, and reinforcement learning using the simulation result can be realized.

Specifically, when the tip end maximum resin pressure and the volume filling ratio are converted into the degree of defect of the molded article 6, the fluid analysis device 4 and the learning device 15 can be connected to each other, and reinforcement learning using the simulation result can be realized.

Furthermore, when using the observation data obtained by actual molding as observation data required when creation of the state expression map 12b is subjected reinforcement learning, the learning device 15 can be subjected to reinforcement learning.

Furthermore, when adjusting the weighing value of the resin material, the V/P switching position, the holding pressure, and the injection velocity which are variable parameters, it is possible to reduce the defect of the molded article 6.

Note that, in this embodiment, description has been given of an example in which the variable parameter adjustment device 1 and the machine learning device are provided in the molding machine 2, but one or both the variable parameter adjustment device 1 and the machine learning device may be configured separately from the molding machine 2. In addition, the variable parameter adjustment processing or the machine learning processing may be configured to be executed in a cloud.

In addition, in this embodiment, description has been mainly given of the model-based reinforcement learning, but the invention may be applied to model-free-based reinforcement learning.

In addition, in this embodiment, description has been mainly given of an example in which the variable parameter of the molding machine 2 that is an injection molding machine is adjusted, but the invention may be applied to other molding machines 2 such as an extruder.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-12. (canceled)

13. A machine learning method of a learning model that outputs a variable parameter in a case where observation data obtained by observing a physical quantity relating to actual molding using a molding machine is input to the learning model,
wherein the variable parameter is configured to reduce the degree of defect of a molded article obtained by actual molding and relates to molding conditions of the molding machine, the machine learning method comprising:
simulating a molding process by setting a variable parameter and a fixed parameter to a fluid analysis device simulating a molding process;
acquiring a defect-related parameter that is obtained by simulation;
calculating the degree of defect of the molded article on the basis of the acquired defect-related parameter; and
causing the learning model to perform machine learning by using the variable parameter set to the fluid analysis device and reward corresponding to the calculated degree of defect.

14. The machine learning method according to claim 13,
wherein the molding process is simulated by setting a value to the fluid analysis device as the fixed parameter for simulation, the value being obtained by changing a fixed parameter for the molding machine, and
the fixed parameter for simulation is determined so that a result of actual molding and a result of simulation match each other.

15. The machine learning method according to claim 13,
wherein the molding process is simulated by setting a resin temperature to the fluid analysis device, the resin temperature being lower than a resin temperature that is set to the molding machine, and
the resin temperature for simulation is determined so that a result of actual molding using the molding machine and a result of simulation using the fluid analysis device match each other.

16. The machine learning method according to claim 13,
wherein association information for associating the defect-related parameter and the degree of defect of the molded article is specified, the defect-related parameter being obtained by simulation using the same variable parameter and the fixed parameter as the variable parameter and the fixed parameter set to the molding machine, the degree of defect being obtained by actual molding performed by setting the variable parameter and the fixed parameter to the molding machine, and
the degree of defect of the molded article is calculated from the defect-related parameter by using the specified association information.

17. The machine learning method according to claim 13,
wherein the defect-related parameter includes,
at least one of a volume filling ratio, a pressure, a temperature, a V/P switching position, a V/P switching pressure, viscosity, a solid phase rate, a skin layer thickness, a filling speed, filling acceleration, a shear stress, a stress, a density, a shear rate, shear energy, a thermal conductivity, and specific heat of the resin material in a mold, and an interfacial temperature between the resin and the mold.

18. The machine learning method according to claim 13,
wherein the learning model is subjected to reinforcement learning on the basis of observation data that is a fixed value, the variable parameter set to the fluid analysis device, and reward corresponding the degree of defect relating to the defect-related parameter obtained by simulation.

19. The machine learning method according to claim 13,
wherein the learning model is subject to reinforcement learning on the basis of the observation data obtained by observing the physical quantity relating to actual molding performed by setting the variable parameter and the fixed parameter to the molding machine, the variable parameter set to the molding machine, and reward corresponding to the degree of defect obtained by actual molding, and the learning model is subjected to the reinforcement learning on the basis of the observation data that is a fixed value, the variable parameter set to the fluid analysis device, and reward corresponding the degree of defect relating to the defect-related parameter obtained by simulation.

20. The machine learning method according to claim 18,
wherein the observation data that is a fixed value is one piece of observation data obtained by observing the physical quantity relating to actual molding performed by setting the variable parameter to the molding machine.

21. The machine learning method according to claim 13,
wherein the variable parameter includes a switching position between injection velocity control and injection pressure control in injection molding, an injection velocity, or a holding pressure.

22. A non-transitory computer readable recording medium storing a computer program for causing a computer to perform machine learning of a learning model that outputs a variable parameter in a case where observation data obtained by observing a physical quantity relating to actual molding using a molding machine is input to the learning model,
wherein the variable parameter is configured to reduce the degree of defect of a molded article obtained by actual molding and relates to molding conditions of the molding machine, the computer program causing the computer to execute processes of:
simulating a molding process by setting a variable parameter and a fixed parameter to a fluid analysis device simulating a molding process;
acquiring a defect-related parameter that is obtained by simulation;
calculating the degree of defect of the molded article on the basis of the acquired defect-related parameter; and
causing the learning model to perform machine learning by using the variable parameter set to the fluid analysis device and reward corresponding to the calculated degree of defect.

23. A machine learning device that causes a learning model to perform machine learning, wherein
the learning model outputs a variable parameter in a case where observation data obtained by observing a physical quantity relating to actual molding using a molding machine is input to the learning model, and
the variable parameter is configured to reduce the degree of defect of a molded article obtained by actual molding and relates to molding conditions of the molding machine,
the machine learning device comprising:
a processor; and
a storage storing instructions for causing the processor to execute processes of:
simulating a molding process by setting a variable parameter and a fixed parameter to a fluid analysis device simulating a molding process;
acquiring a defect-related parameter that is obtained by simulation by the fluid analysis device;
calculating the degree of defect of the molded article on the basis of the acquired defect-related parameter; and
causing the learning model to perform machine learning by using the variable parameter set to the fluid analysis device and the calculated degree of defect.

24. A molding machine, comprising:
the machine learning device according to claim 23,
wherein actual molding is performed by using a variable parameter output from the learning model.
